(19) United States
(12) Patent Application Publication
(10) Pub. No.: US 2010/0275186 A1
(43) Pub. Date: Oct. 28, 2010

(54) SEGMENTATION FOR STATIC ANALYSIS

(75) Inventors: Conal McGarvey, Seattle, WA (US); Vladimir A. Levin, Redmond, WA (US); Jakob F. Lichtenberg, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/431,187

(22) Filed: Apr. 28, 2009

(51) Int. Cl. G06F 9/44

(52) U.S. Cl. 717/132; 717/131

(57) ABSTRACT

Various embodiments provide techniques to segment program code that may be the subject of static analysis. In one or more embodiments, an algorithm is applied to an abstract representation of the program code to derive segments for the program code. In at least some embodiments, multiple segments can be derived based at least in part upon of one or more “boxed” portions of the program code that are designated to remain intact within the segments. Each segment can then be subjected individually to static analysis to verify compliance with one or more prescribed behaviors. Verification results can be output for each individual segment and the individual results can be combined to obtain results for the program code overall.

### BACKGROUND

In many code development scenarios it can be desirable to verify that code adheres to rules prescribed for interaction of the code with other components. An example of such a scenario is in the context of device driver code that may interact with various operating system features (e.g., functions, interfaces, services, and so forth) to cause operation of a corresponding device.

Traditional approaches to code verification have, in some instances, provided unreliable results. Specifically, in some approaches, verification involves static analysis of code that is performed to verify compliance of the code as a whole against a set of rules. However, these approaches can result in relatively high instances of non-useful results due to the size and complexity of the code and associated difficulties that may be encountered when attempting verification (e.g., resource overloading, “timing out”, and so forth). Moreover, as these approaches may return incomplete results for a given rule, verification of code as a whole may not provide exhaustive results as to which portion of the code may have been the cause of a non-compliant result.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments provide techniques to segment program code that may be the subject of static analysis. In one or more embodiments, an algorithm is applied to an abstract representation of the program code to derive segments for the program code. In at least some embodiments, multiple segments can be derived based at least in part upon one or more “boxed” portions of the program code that are designated to remain intact within the segments. Each segment can then be subjected individually to static analysis to verify compliance with one or more prescribed behaviors. Verification results can be output for each individual segment and the individual results can be combined to obtain results for the program code overall.

### BRIEF DESCRIPTION OF THE DRAWINGS

FIG. 1 illustrates an example operating environment in which one or more embodiments of segmentation for static analysis can be employed.

FIG. 2 is a flow diagram that describes an example procedure in accordance with one or more embodiments.

FIG. 3 is a flow diagram that describes an example procedure in accordance with one or more embodiments.

FIG. 4 is a diagram that depicts an example control flow graph that can be employed to derived segments in accordance with one or more embodiments.

FIG. 5 is a diagram that depicts a compressed control flow graph and pathways of the control flow graph in accordance with one or more embodiments.

FIG. 6 is a diagram that depicts an example segment that can be formed in accordance with one or more embodiments.

FIG. 7 is a diagram that depicts an example environment model architecture for a module in accordance with one or more embodiments.

FIG. 8 is a block diagram of a system that can implement the various embodiments.

### DETAILED DESCRIPTION

Overview

Various embodiments provide techniques to segment program code that may be the subject of static analysis. In one or more embodiments, an algorithm is applied to an abstract representation of the program code to derive segments for the program code. In at least some embodiments, multiple segments can be derived based at least in part upon one or more “boxed” portions of the program code that are designated to remain intact within the segments. Each segment can then be subjected individually to static analysis to verify compliance with one or more prescribed behaviors. Verification results can be output for each individual segment and the individual results can be combined to obtain results for the program code overall.

In the discussion that follows, a section entitled “Operating Environment” describes but one environment in which the various embodiments can be employed. Following this, a section entitled “Segmentation Examples” describes example techniques and algorithms for segmentation in accordance with one or more embodiments. Next, a section entitled “Module-Centric Verification” describes example implementations of segmentation techniques in accordance with one or more embodiments. Last, a section entitled “Example System” is provided and describes an example system that can be used to implement one or more embodiments.

Operating Environment

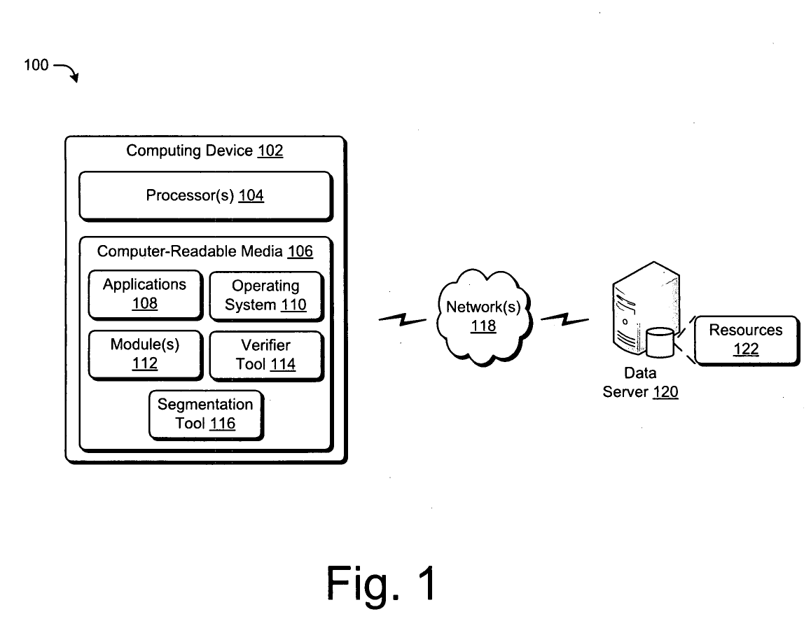

FIG. 1 illustrates an operating environment in accordance with one or more embodiments, generally at 100. Environment 100 includes a computing device 102 having one or more processors 104, one or more computer-readable media 106 and one or more applications 108 that are stored on the computer-readable media and which are executable by the one or more processors 104. The computer-readable media 106 can include, by way of example and not limitation, all forms of volatile and non-volatile memory and/or storage media that are typically associated with a computing device. Such media can include ROM, RAM, flash memory, hard disk, optical disks, removable media, and the like. Computer-readable media 106 is also depicted as storing an operating system 110, one or more modules 112, a verifier tool 114, and a segmentation tool 116 that may also be executable by the processor(s) 104. While illustrated separately, the segmentation tool 116 may also be implemented as a component of the verifier tool 114. Additionally or alternatively, functionality represented by the verifier tool 114 and segmentation tool 116 may be provided by way of different computing devices.

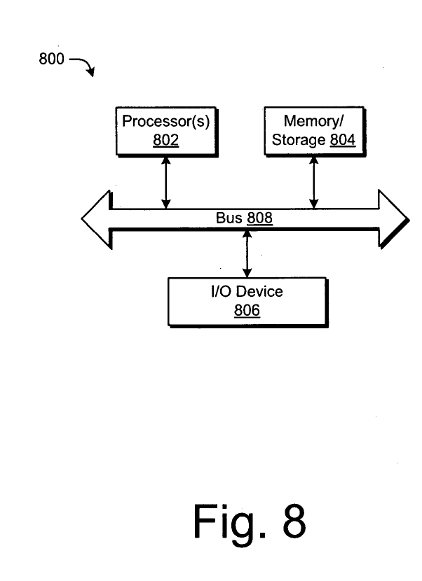

Computing device 102 can be embodied as any suitable computing device such as, by way of example and not limitation, a desktop computer, a portable computer, a server, a handheld computer such as a personal digital assistant (PDA), cell phone, and the like. One specific example of a computing device is shown and described below in relation to FIG. 8.

Applications 108 can include any suitable type of application to provide a wide range of functionality to the computing device 102, including but not limited to applications for office productivity, email, media management, printing, networking, web-browsing, and a variety of other applications. The modules 112 represent various suitable program code, applications, functions, and other software that may be the subject of static analysis. Examples of modules 112 that may be subjected to static analysis include, but are not limited to, the applications 108, functions, device drivers, a driver stack, protocol modules, service modules, and so forth.

The verifier tool 114 represents functionality operable to perform static analysis upon various modules 112. The verifier tool 114 can operate to verify adherence of the modules 112 to prescribed behaviors and/or rules configured to check for the behaviors. In at least some embodiments, this involves determining compliance of a subject program code (e.g., a module 112) with rules that may be defined for interaction of the program code with other components. These other component can include other software modules, functions of the operating system, application programming interfaces, hardware registers, and interrupts, to name a few. Verifier tool 114 can be configured in any suitable way to perform verification of modules 112 to determine compliance with rules defined relative to an environment in which the code operates. For instance, static analysis may involve determining that various pathways into and throughout code of the modules 112 behave as intended for a particular environment, such a particular operating system, a module stack, a functional sub-system of a computing device 102, and so forth. By way of example and not limitation, verifier tool 114 can be configured to verify various interactions of drivers with the operating system 110. One example of a suitable verifier tool that can be employed with techniques described herein is Static Driver Verifier (SDV) available from Microsoft Corporation.

The segmentation tool 116 represents functionality operable to derive segments for program code to be verified. For example, segmentation tool 116 can operate to apply one or more algorithms to derive segments for the program code. Segments can be derived in any suitable way. In general, in at least some embodiments, the segments are derived such that static analysis of the segments individually provides results that are equivalent to results that would be obtained if program code was verified as whole. Each segment of program code can then be input individually to verifier tool 114 for static analysis. Moreover, different segments may be analyzed by different verifier tools that may be executed via different processors and/or computing devices. Verification results can be output for each individual segment and can then be combined to obtain results for the program code overall. By doing so, the burden on a particular verifier tool 114 may be reduced relative to analysis of program code as a whole. As such, analysis may occur faster and with fewer instances of non-useful results, “time-outs”, resource overloading, or other difficulties encountered in traditional techniques for static analysis.

As further illustrated in FIG. 1, computing device 102 may be connected by way of one or more networks 118 to a data server 120. Data server 120 may maintain various resources 122 (e.g., content, services, and data) that can be made available to the computing device 102 over a network 118. For instance, resources 122 may include various modules 112, program code, tools, or other suitable software that may be provided to the computing device 102. Resources 122 may also include segments of code to be verified for distribution over the network 118 to one or more computing devices configured to perform static analysis. Further, resources 122 may include a static analysis service that may be implemented to coordinate aspects of segmentation techniques when performed in a distributed manner between devices over the network 118.

Having considered an example operating environment, consider now segmentation examples in accordance with one or more embodiments.

Segmentation Examples

The following discussion describes segmentation techniques related to static analysis that may be implemented utilizing the environment, systems, and/or devices described above and below. Aspects of each of the procedures below may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference may be made to the example environment 100 of FIG. 1.

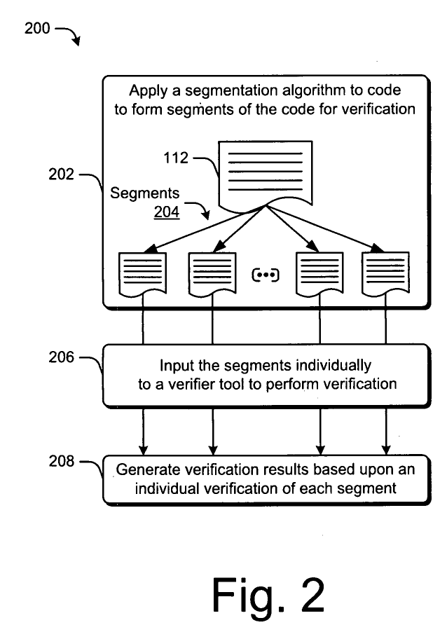

FIG. 2 is a flow diagram that describes an example procedure 200 in accordance with one or more embodiments. In at least some embodiments, the procedure 200 can be performed by a suitably configured computing device, such as computing device 102 of FIG. 1.

Step 202 applies a segmentation algorithm to code to form segments of the code for verification. As illustrated in FIG. 2, a module 112 or other suitable program code may be divided into a plurality of segments 204 for the purposes of verification by a suitable verifier tool 114. Each of the segments 204 contains a portion of the code to be verified. A segment corresponds to a portion of the original code that can execute in the same manner as the overall program itself along branches within the segment, while ignoring branches that may be included in other segments.

One way that segmentation can occur is by operation of a segmentation tool 116 (FIG. 1) that is configured to apply a segmentation algorithm to the module 112. In at least some embodiments, the segmentation tool 116 makes use of an algorithm to construct each segment from an abstract representation of the module. Each segment can be generated based upon an abstracted pathway through the code, as discussed in greater detail in the examples below. Segmentation tool 116 may also makes use of configurable tuning parameters to control the size and/or number of segments that are generated. For example, one parameter may set upper and/or lower bounds on the number of segments. Another parameter may set a minimum and/or maximum size for segments. The size may be expressed as a number of nodes, a size in bytes, and so forth. A variety of suitable algorithms and parameters can be used to derive the segments 204, further discussion of which may be found in relation to the figures below.

Step 206 inputs the segments individually to a verifier tool to perform the verification. Verification of segments can occur in a variety of ways. For example, segmentation tool 116 may cause static analysis to be performed on the basis of the segments 204 generated in step 202. One way this can occur is by inputting the segments to a verifier tool 114 of a computing device one after another. Additionally or alternatively, a computing device may execute multiple verifier tools 114 to process different modules and/or segments concurrently. In yet another example, different segments may be input to and/or analyzed by different computing devices and corresponding verifier tools. These different computing devices used for static analysis can be connected locally or remotely over one or more networks.

Step 208 generates verification results based upon an individual verification of each segment. As noted, in at least some embodiments, the segments can be derived such that static analysis of the segments individually provides results that are equivalent to results that would be obtained if the program code was verified as whole. Accordingly, results for the un-segmented module 112 can be obtained by combining the results of analysis performed upon the segments 204.

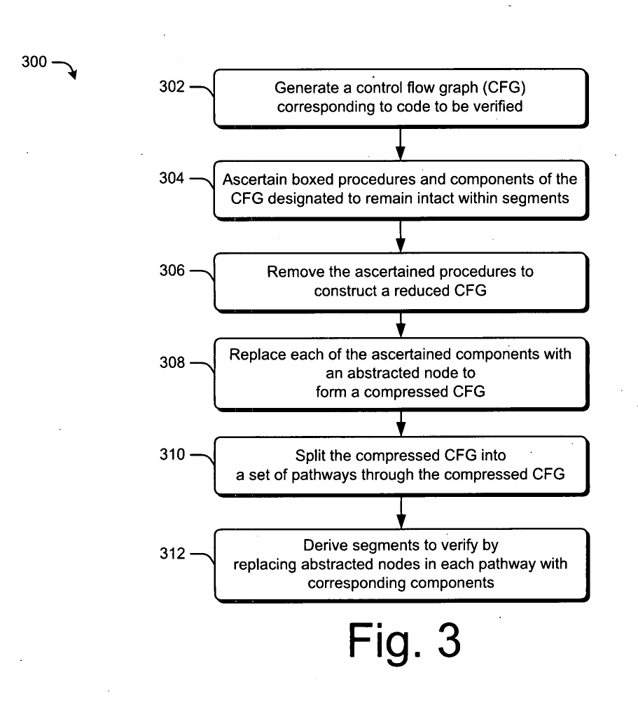

FIG. 3 is a flow diagram that describes an example procedure 300 in accordance with one or more embodiments. In at least some embodiments, the procedure 300 can be performed by a suitably configured computing device, such as computing device 102 of FIG. 1 having a segmentation tool 116. In particular, procedure 300 represents an example segmentation algorithm that may be implemented to derive segments for static analysis.

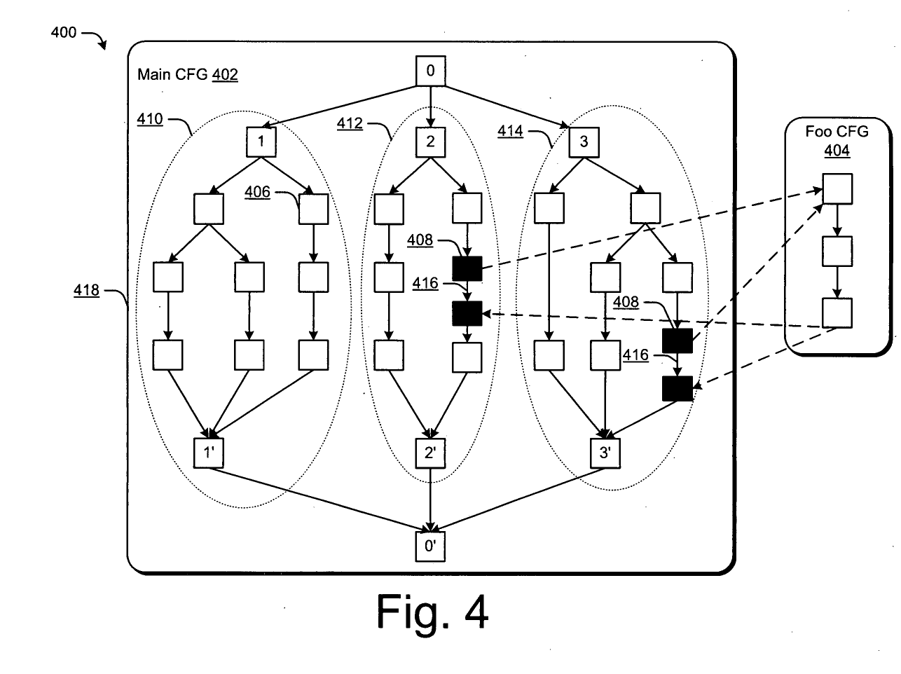

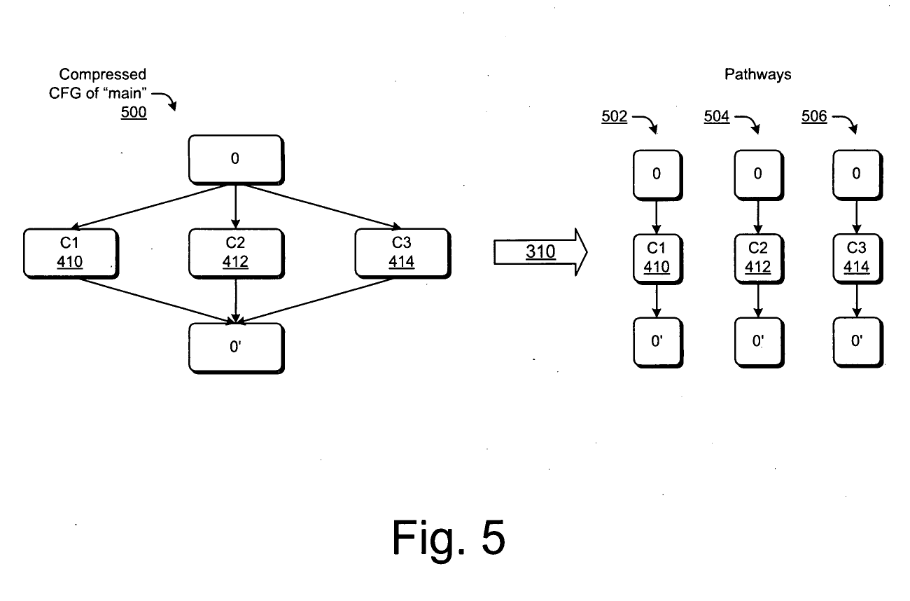

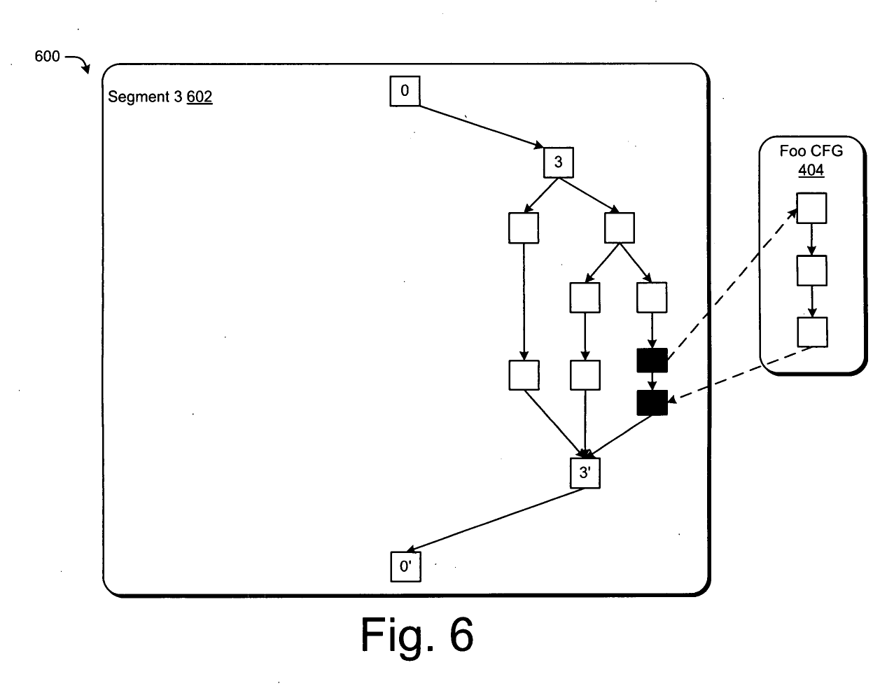

In the discussion of procedure 300, reference may be made to the segmentation examples depicted in FIGS. 4-6, which are now briefly introduced. FIG. 4 depicts an example implementation 400 of configuration flow graph (CFG) that corresponds to a module 112 that may be the subject of static analysis. FIG. 5 depicts an example implementation 500 of a compressed version of the CFG that may be constructed in the course of segmenting a module 112. FIG. 5 further depicts example pathways corresponding to the compressed version of the CFG. FIG. 6 depicts an example implementation 600 of a segment that can be generated using the CFG, the compressed CFG, and/or corresponding pathways in accordance with one or more embodiments.

Referring back to procedure 300, step 302 generates a control flow graph (CFG) corresponding to code to be verified. A control flow graph can be generated in any suitable way. For example, segmentation tool 116 can be configured to examine program code to generate a corresponding control flow graph for a program. In at least some embodiments, this can occur automatically without user action. Additionally or alternative, segmentation tool 116 can expose user interfaces to enable examination of program code by a developer. Segmentation tool 116 can then generate a CFG responsive to input from the developer.

Generally, a control flow graph (CFG) of program code is an abstract representation of the program code as a plurality of nodes each of which might be one or more instructions of the code. By way of example and not limitation, the nodes can each represent an instruction, a sequence of instructions, a function, an inter-procedural call-site (e.g., a pair of nodes having a call node followed by a return node), and so forth. The control flow graph of the program code may be augmented with inter-procedural calls (e.g., calls to external functions, programs, interfaces, and so forth) by mapping nodes in a CFG of the procedure to call-site pair nodes (call/return nodes) in the CFG of the program code.

As noted, one example of a control flow graph is depicted in FIG. 4. In particular, FIG. 4 depicts an example implementation 400 having a Main CFG 402 for a program “main” connected to a Foo CFG 404 for an external program “foo”. The depicted CFGs are configured as a plurality of nodes 406 that are interconnected to represent the flow of the programs. Note that Main CFG 402 and Foo CFG 404 are interconnected by node pairs 408, shown in black, that represent inter-procedural interaction (e.g., calls and returns) between the programs “main” and “foo”. In the Main CFG, the program flow for “main” can occur from an entry node 0 to an exit node 0′. Moreover, program flow for “main” can occur along multiple pathways from the entry node 0 to the exit node 0′. In particular, multiple pathways travelling from node 1 to node 1′, node 2 to node 2′, and node 3 to node 3′ exist in the depicted Main CFG 402. Control flow graphs, such as those illustrated in FIG. 4, can be employed to derive segments for static analysis.

In particular, using the control flow graph obtained in step 302, step 304 ascertains boxed procedures and components of the control flow graph designated to remain intact within segments. For example, segmentation tool 116 can be configured to determine a set of procedures and components of a CFG as “boxed”. As used herein “boxed” refers to portions of program code that are designated to remain intact within segments. In other words, a segmentation algorithm applied via a segmentation tool 116 can be configured to take portions of a CFG that are boxed as a whole into the corresponding segment. As such, designating a portion as “boxed” can prevent the portion from being split into smaller parts for the purpose of segmentation. In the context of a CFG for a program, procedures can refer to the external programs invoked through inter-procedural calls, such as “Foo” depicted in FIG. 4. Components can refer to sub-graphs of the nodes that make up the overall CFG.

Ascertaining of boxed procedures and/or boxed components can occur based upon various tuning parameters defined to balance the size and/or number of segments derived for program code. Such tuning parameters can include parameters to directly specify values for a size and/or number of segments as discussed above. Additionally or alternatively, parameters can also be set to specify criteria for selection of boxed portions, e.g., how to select the portions. Segmentation tool 116 can make use of these and other suitable parameters to perform segmentation. In at least some embodiments, a developer can interact with a segmentation tool 116 to provide input to configure the various parameters to tune segmentation and/or static analysis of the segments. For example, when static analysis of segments derived for program code results in an unacceptable level of non-useful results, tuning parameters can be updated accordingly to cause a different set of segments to be derived for another analysis pass.

Various boxed portions of program code can be designated in any suitable way. For example, boxed procedures can be designated by way of a list of procedure names. Segmentation tool 116 can reference this boxed procedure list to ascertain the corresponding procedures. In at least some embodiments, each recursive procedure of program code can be included in the boxed procedure list. Accordingly, in the example CFG of FIG. 4, the node pairs 408 representing inter-procedural interaction can each be designated as boxed procedures using a list or another suitable technique. Additionally or alternatively, some procedures can remain un-boxed and accordingly segmentation can cause these unboxed procedures to be split apart in some instances.

Designation of boxed components can also occur in various other ways. In one example, boxed components can correspond to portions of the CFG having designated characteristics. Examples of the designated characteristics include, but are not limited to, the shape of a portion, functionality provided by the portion, and variable values/conditions associated with a portion (e.g., flow into a portion of the code can be conditioned upon designated variable values such as x=1, y>5, and so forth), to name a few. Boxed components can be derived from the CFG using the various characteristics. In some embodiments, nodes and/or portions of the CFG can include labels, names, metadata, and/or other annotations that can be employed to describe the characteristics. Accordingly, segmentation tool 116 can make use of such annotations to derive the boxed components. Additionally or alternatively, segmentation tool 116 can be configured to process the CFG to derive boxed components using parameters that can be input as discussed above to define the various characteristics.

In one particular example, specification of boxed components can be based on a concept of diamond shaped sub-graphs of a CFG. The diamond is defined as a portion of the CFG that has one entry node and one exit node. Accordingly, flow into the diamond from other parts of the CFG occurs at the entry node and flow out of the diamond to other parts of the CFG occurs from its exit node. Note that diamonds may be configured in a variety ways. For instance a thin diamond may be configured as a sequence of blocks and nodes that occur one after the other along one path from an entry node to an exit node. A branching or wide diamond can represent a switch or conditional statement and accordingly may have two or more paths from its entry node to its exit node. Further, wide diamonds can include two or more sub-diamonds that can be referred to as the branches of the wide diamond.

Given a CFG, boxed components can be defined as diamonds of the CFG. In other words, boxed components can be selected as portions of the CFG having one entry node and one exit node. In at least some embodiments, each distinct diamond of a CFG is designated as a boxed component. Further, diamonds can be selected at different levels of granularity within the CFG using tuning parameters described above. For example diamonds between node pair (0, 0′) of FIG. 4 may constitute a first level. Each sub-diamond of the first level, represented in FIG. 4 by node pairs (1, 1′) (2, 2′), and (3, 3′), can include one or more diamonds at a second level, and so on. As such, the tuning parameters can be set to control a level at which boxed components are specified. Generally, designating boxed components at a lower level can result in more segments being derived.

Consider again the example CFG depicted in FIG. 4. In this example, boxed components can be defined to include the diamonds formed by each of node pairs (1, 1′) (2, 2′), and (3, 3′). In particular, FIG. 4 depicts boxed components 410, 412, and 414, which are represented using dashed ovals surrounding respective node pairs (1, 1′), (2, 2′), and (3, 3′). In this manner, segmentation tool 116 can make use of a CFG to designate and/or ascertain various boxed procedures and components.

Step 306 removes the ascertained procedures to construct a reduced CFG. This step can involve abstracting the inter-procedural edges. In particular, nodes of the CFG representing a call to and return from another procedure can be abstracted by directly connecting the call node to the return node. For instance, in the example CFG of FIG. 4, the node pairs 408 connecting “main” to “foo” can be abstracted by removing the inter-procedural flow represented by the dashed arrows. Then, the call node can be directly connected to the corresponding return node for each of the node pairs 408 as shown by the connections 416 in FIG. 4. By so doing, the inter-procedural interaction with “foo” is removed to form a reduced CFG. The reduced CFG 418 in FIG. 4 is represented by a box that includes the Main CFG 402 with the connections 416 made to remove inter-procedural interaction with “Foo”.

Step 308 replaces each of the ascertained components as an abstracted node to form a compressed CFG. Then, in step 310 the compressed CFG is split into a set of pathways through the compressed CFG. For example, the boxed components ascertained in step 304 can be abstracted by replacing each of the boxed components with a representative node. In particular, segmentation tool 116 can operate to replace each of the boxed components 410, 412, 414 depicted within the reduced CFG 418 as an abstracted node. In other words, the multiple nodes contained in each of the dashed ovals in FIG. 4 can be replaced by a single node in the CFG to represent corresponding boxed components. By so doing, the boxed components can be abstracted to form a compressed CFG.

To further illustrate, consider now FIG. 5, which depicts an example compressed CFG 500 corresponding to the Main CFG 402 of FIG. 4. Note that in the compressed CFG 500 each of the boxed components 410, 412, 414 is represented by an abstracted node. Segmentation tool 116 can make use of the compressed CFG 500 to derive a set of pathways through the CFG.

For instance, FIG. 5 further illustrates formation of a set of pathways by splitting of the compressed CFG 500. Specifically, segmentation tool 116 can operate to split the CFG 500 into distinct pathways between entry and exit nodes of the compressed CFG. Example pathways 502, 504, and 506 between nodes (0, 0′) are illustrated in FIG. 5 as being formed from the example CFG 500 through step 310. In this example, each pathway corresponds to one of the abstracted nodes used to represent the boxed components. In other cases, complex pathways can be formed which each contain one or more boxed components represented by a compressed CFG.

Step 312 derives segments to verify by replacing the abstracted nodes in each pathway with corresponding components. For instance, the information abstracted to form the compressed CFG in step 308 can be returned to the abstracted nodes in the pathways formed in step 310. In addition, inter-procedural interaction can be restored by reconnecting call/return nodes of boxed procedures to the corresponding procedures. In this manner, a set of segments is obtained that can be used to perform static analysis of corresponding program code. Specifically, segments derived using procedure 300 can be input individually to a verifier tool 114 to perform verification in accordance with techniques described above and below.

An example segment that can be derived from the Main CFG 402 is depicted in FIG. 6. In particular, FIG. 6 depicts generally at 600 an example segment 602 that can be formed by replacing the abstracted node in pathway 506 of FIG. 5 with un-abstracted nodes of the corresponding boxed component 414. Further, the node pair 408 shown in FIG. 4 for the boxed component 414 can be reconnected to the procedure “Foo”. The result is the segment 602 shown in FIG. 6. Similar segments can be formed for the pathways 502 and 504. Accordingly, the Main CFG 402 can be split into three distinct segments to perform static analysis of the corresponding program “main”.

As discussed previously, static analysis using segments and segmentation techniques described herein can, in at least some embodiments, provide results that are equivalent to a successful analysis of program code as a whole. Moreover, analysis of the segments can be performed faster than the time it would take to analyze the program code as a whole. Additionally, instances in which non-useful results, time-outs, resource overloading and/or other problems with analysis occur can be reduced by analysis of the segments instead of the program code as a whole. As such, a success rate for static analysis performed using the segments can be higher relative to a success rate for static analysis performed using the program code as a whole.

Having described example embodiments involving segmentation of program code for static analysis, consider now specific implementation examples that can be employed with one or more embodiments described herein.

Module-Centric Verification

In at least some embodiments, segmentation techniques described herein can be employed to perform analysis of a module 112 in the context of an environment model (EM). Such analysis may be referred to herein as module-centric verification. An example of module-centric verification is static analysis of a device driver in the context of an operating system model. In the discussion below, first a general description of a module in the context of its environment model is provided. Then, application of segmentation techniques described herein to perform module-centric verification is discussed.

In one or more embodiments, modules 112 may be configured to interact with various features of a corresponding environment. As used herein, a module 112 can have various entry points which may be called by the environment. The module can also call procedures available from the environment. Different entry points and procedure calls for a particular module may be executed in different situations. Accordingly, there can be a variety of different pathways through the code.

In this context, an environment model may represent a sub-set of functionality available from a corresponding environment. This can include calls made into the module (calls to the entry points) and procedures that may be accessed by the module from the environment. The environment model can be constructed to simplify analysis by reducing the sphere of interaction for the subject program code.

In the example of driver verification, the environment model may be configured as an operating system model to represent a sub-set of functionality available from a corresponding operating system 110. While it is possible to perform verifications using a complete operating system, the operating system model may be employed to reduce the sphere of interaction to be verified. One way this can occur is by configuring the operating system model to represent a portion of the operating system with which program code being verified is designed to interact. Thus, the operating system model may represent the various procedures and interfaces (e.g., device driver interfaces DDIs) that a driver may call. The operating system model may also mimic calls from the operating system to the driver. For example, in the case of a printer driver, the operating system model employed may represent a print subsystem of the operating system.

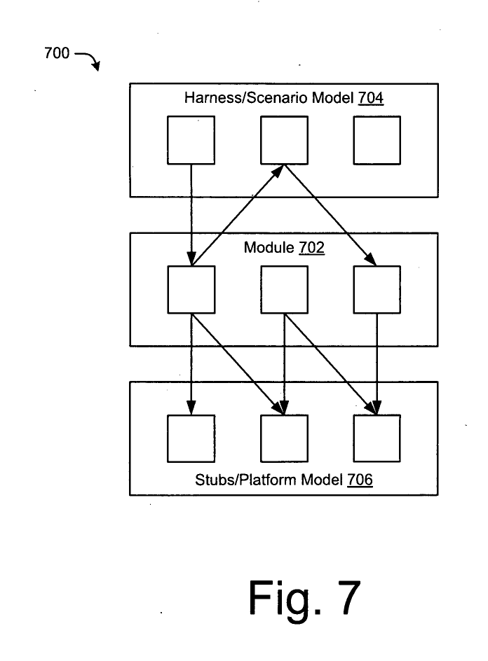

In other settings, similar environment models representing an environment in which code operates can be constructed and employed. The environment model may be constructed to include upper and lower layers to interact with a module to be verified. These layers may structurally wrap the module to be verified. An example of such an architecture is depicted in FIG. 7.

In particular, FIG. 7 is a diagram that depicts an example architecture 700 of a module 702 in the context of a corresponding environment model. The example module 702 is depicted as being wrapped by upper and lower layers that can be configured to make up a corresponding environment model. The upper layer is illustrated as a harness 704 that represents calls made into the module from the corresponding environment. The upper layer may also be referred to as a scenario model. The lower layer is illustrated as stubs 706 that represent procedures of the environment that may be called from the module 702. These procedures may also be referred to as a platform model. Thus, the environment model is constructed to mimic the behavior of the environment using the harness 704 as the upper layer and stubs 706 as the lower layer.

For example, in module-centric verification, a set of procedures for the environment model are identified that can be called by a module, which is the subject of static analysis. This set of procedures is designated as a “platform” and can be used to construct the stubs 706 of the lower layer. In at least some embodiments, the platform procedures can be replaced with their non-deterministic models to obtain the stubs 706. The stubs 706 can then be linked to the module 702 within the architecture 700.

Additionally, a non-deterministic model of call scenarios (entry points) into the module from other parts of the environment can be constructed to form the harness 704 of the upper layer. The harness 704 contains the “primary” procedures of the environment that interact with the module 702 linked to the stubs 706. As noted, the module's procedures called directly from the harness 704 are referred to as entry points of the module.

Having considered the example architecture 700 depicted in FIG. 7, consider now application of segmentation techniques to a module 702 within such a context. Module-centric verification for a module in the context of its environment model can be performed using the general techniques and algorithms described herein. In particular, the module 702 combined with the harness 704 and stubs 706 can be considered complete program code. As such, a control flow graph comparable to the one depicted in FIG. 4 can be obtained for the module-centric case. Further, a segmentation algorithm, such as the procedure 300 of FIG. 3, can be applied to derive segments for module-centric verification.

Note that segmentation for module-centric verification can involve tailored techniques to specify boxed procedures and components. In at least some embodiments each of a module's procedures and stubs are designated as boxed procedures. In this case, the specification of boxed components is reduced to the scope of the harness.

In one or more embodiments, the boxed components can be designated based upon the entry points into the module that are called by the harness. One way this can occur is by splitting the harness into sequences of calls to different entry points into the module. Then, each such sequence can be used to build a segment around it.

In one example, a harness can be segmented based upon functionality. For instance, different entry points for a module can correspond to different functionality. By way of example, a module can have different entry points corresponding to read from device, write to device, and control device. Accordingly, a portion of the harness that calls the read entry point can be designated as one boxed component, a portion that calls the write entry point can be designated as another boxed component, and a portion that calls the control entry point can be designated as yet another boxed component. When segmentation is performed, three segments can be formed that correspond to the read, write, and control functionality respectively. Then, verification can be performed using these functionally derived segments.

In another example, a harness can be segmented based upon the structure of the harness. For instance, a harness can be structured as a sequence of diamonds that follow one after other in “a diamond chain”. Within the diamond chain, wide (branching) diamonds in which each branch contains a call-site corresponding to an entry point of the module can be designated as a layer. Likewise, wide diamonds that do not contain call-sites of entry points of the module can be excluded from the layers. Thus, call-sites corresponding to entry points of the module are contained within these designated layers of the harness. As such, the layers can represent switches that control selection of entry points. Additionally, standalone call-sites of some entry points can appear before a top layer, within interim diamonds between two layers, or after a bottom layer in the diamond chain. These three locations for standalone call-sites can be designated as PRE, CORE, and POST, respectively.

To segment the harness based on such a structure, each diamond of the harness can be designated as a boxed component with the exception of the layers. In other words, when segmentation occurs, the diamonds that are layers can be split and the other “boxed” diamonds can remain intact. Once the layers are derived, a segmentation algorithm can be applied to form segments in accordance with various techniques discussed herein. For example, segmentation tool 116 can be configured to analyze the structure and automatically derive the layers. Further, segmentation tool 116 can infer the set of boxed components from the derived layers as described above.

Additionally or alternatively, the structure of a harness including the layers can be explicitly specified in a variety of ways. One way this can occur is by annotating a CFG graph to include metadata, identifiers, or other suitable designations to describe the structure. In at least some embodiments, the structure of a harness can be specified using a language that makes use of the PRE, CORE, and POST designations. An example of such a specification can be configured in the following form:
PRE(A0), LAYER1(B1), CORE1(A1), . . . LAYERn(Bn), POST(An)
   In this example, each of A0, B1, A1, . . . , Bn, and An represents a list of entry points that can be called by a corresponding part of a harness. Layers can be explicitly designated by the designator LAYER. Other harness portions can be designated using corresponding PRE, CORE, and POST designators. This specification reveals distribution of entry points along the layered structure of the harness. Such explicit specification of the harness structure can be used as an alternative to automatic detection of layers. Further, the specification also enables deviation from a standard structure, such as designating as layers some branches of the harness that do not include call-sites corresponding to entry points of the module. Based on the specified structure, layers can be ascertained and designated and boxed components can be defined for portions other than the layers as discussed above. Segmentation of the harness can then occur based on the boxed components. Note that portions of the harness designated as layers can be split in the course of forming segments. Then the segments that are formed can be input individually to a verifier tool 114 to perform static analysis of the corresponding module in accordance with techniques described herein.

Having discussed module-centric implementation examples of segmentation techniques described herein, consider now a discussion of an example system that can be used to implement one or more embodiments.

Example System

FIG. 8 illustrates an example computing device 800 that can implement the various embodiments described above. Computing device 800 can be, for example, a computing device 102 of FIG. 1, a data server 120 of FIG. 1, or another suitable computing device.

Computing device 800 includes one or more processors or processing units 802, one or more memory and/or storage components 804, one or more input/output (I/O) devices 806, and a bus 808 that allows the various components and devices to communicate one to another. The bus 808 represents one or more of several types of bus structures, including a memory bus or memory controller, a peripheral bus, an accelerated graphics port, and a processor or local bus using a variety of bus architectures. The bus 808 can include wired and/or wireless buses.

Memory/storage component 804 represents one or more computer storage media. Memory/storage component 804 can include volatile media (such as random access memory (RAM)) and/or nonvolatile media (such as read only memory (ROM), Flash memory, optical disks, magnetic disks, and so forth). Memory/storage component 804 can include fixed media (e.g., RAM, ROM, a fixed hard drive, etc.) as well as removable media (e.g., a Flash memory drive, a removable hard drive, an optical disk, and so forth).

One or more input/output devices 806 allow a user to enter commands and information to computing device 800, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques can be stored on or transmitted across some form of computer-readable media. Computer-readable media can include a variety of available medium or media that can be accessed by a computing device. By way of example, and not limitation, computer-readable media can comprise “computer-readable storage media”.

Software or program modules, including the verifier tool 114, segmentation tool 116, and other program modules, can be embodied as one or more instructions stored on computer-readable storage media. Computing device 800 can be configured to implement particular functions corresponding to the software or program modules stored on computer-readable storage media. Such instructions can be executable by one or more articles of manufacture (for example, one or more computing device 800, and/or processors 802) to implement techniques for segmentation, as well as other techniques. Such techniques include, but are not limited to, the example procedures described herein. Thus, computer-readable storage media can be configured to store instructions that, when executed by one or more devices described herein, cause various techniques related to segmentation for static analysis.

Computer-readable storage media includes volatile and non-volatile, removable and non-removable media implemented in a method or technology suitable for storage of information such as computer readable instructions, data structures, program modules, or other data. Computer-readable storage media can include, but is not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or another tangible media or article of manufacture suitable to store the desired information and which may be accessed by a computer.

Conclusion

Various embodiments provide techniques to segment program code that may be the subject of static analysis. In one or more embodiments, an algorithm is applied to an abstract representation of the program code to derive segments for the program code. In one or more embodiments, multiple segments can be derived based at least in part upon of one or more “boxed” portions of the program code that are designated to remain intact within the segments. Each segment can then be subjected individually to static analysis to verify compliance with one or more prescribed behaviors. Verification results can be output for each individual segment and the individual results can be combined to obtain results for the program code overall.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A computer-implemented method comprising:
segmenting program code to generate segments based at least in part upon one or more portions of the program code designated to remain intact within the segments; and
causing static analysis to be performed of the program code by causing each segment to be individually analyzed.

2. The computer-implemented method of claim 1, wherein segmenting the program code to generate the segments comprises applying an algorithm to a control flow graph (CFG) that represents program flow of the program code as interconnected nodes.

3. The computer-implemented method of claim 2, wherein the algorithm is configured to generate the segments by:
ascertaining boxed procedures and components of the control flow graph (CFG) designated to remain intact;
removing the boxed procedures to form a reduced CFG;
replacing nodes that form each of the boxed components with an abstracted node to form a compressed CFG;
splitting the compressed CFG having the abstracted nodes into multiple pathways through the compressed CFG; and
deriving the segments by replacing abstracted nodes in the multiple pathways with the nodes that form a corresponding boxed component.

4. The computer-implemented method of claim 1, wherein causing static analysis to be performed of the program code comprises inputting each segment individually to a verifier tool configured to perform the static analysis.

5. The computer-implemented method of claim 1, wherein:
the program code corresponds to a module that interacts with an environment model that is constructed to include a harness that interacts with different entry points of the module; and
segmenting the program code comprises segmenting the harness based upon the different entry points.

6. The computer-implemented method of claim 1, further comprising ascertaining the one or more portions of the program code designated to remain intact based upon tuning parameters configured to control a size and number of segments generated.

7. The computer-implemented method of claim 1, wherein causing static analysis to be performed of the program code comprises causing analysis of one of said segments and another of said segments using different respective computing devices.

8. One or more computer-readable storage media storing instructions that, when executed by a computer, cause the computer to apply an algorithm to segment program code for static analysis, the algorithm operable to:
obtain a control flow graph (CFG) representing flow of the program code as a plurality of interconnected nodes;
ascertain one or more boxed components of the CFG designated to remain unsegmented;
abstract ascertained boxed components as abstracted nodes to form a compressed CFG;
split the compressed CFG into multiple pathways; and
replace the abstracted nodes of each of the multiple pathways to form segments of the program code.

9. One or more computer-readable storage media of claim 8, wherein the algorithm is further operable to ascertain the one or more boxed components based upon a tuning parameter to control a number of the segments formed.

10. One or more computer-readable storage media of claim 8, wherein the algorithm is further operable to ascertain the one or more boxed components based upon a tuning parameter to control a size of the segments formed.

11. One or more computer-readable storage media of claim 8, wherein the algorithm is further operable to ascertain the one or more boxed components based upon characteristics of portions of the control flow graph (CFG), the characteristics including one or more of a shape of the portions, functionality provided by the portions, or variable values associated with the portions.

12. One or more computer-readable storage media of claim 8, wherein the algorithm is further operable to:
ascertain one or more boxed procedures of the control flow graph (CFG) designated to remain unsegmented;
remove ascertained boxed procedures from the CFG to generate a reduced CFG; and
form the compressed CFG based upon the reduced CFG.

13. One or more computer-readable storage media of claim 12, wherein the algorithm is further operable to ascertain the one or more boxed procedures based upon a list of procedure names.

14. One or more computer-readable storage media of claim 8, wherein:
the program code corresponds to a device driver and includes a harness configured to mimic interaction of an operating system with entry points of the device driver; and
the one or more boxed components of the control flow graph (CFG) designated to remain unsegmented correspond to one or more portions of the harness associated with different entry points of the device driver.

15. One or more computer-readable storage media of claim 8, wherein the one or more boxed components of the control flow graph (CFG) designated to remain unsegmented correspond to portions of the CFG having one entry node and one exit node.

16. A computer-implemented method comprising:
segmenting program code such that static analysis performed individually upon multiple segments of the program code generates results that are equivalent to results obtainable from a successful static analysis performed on the program code as a whole; and
causing static analysis to be performed on the multiple segments.

17. The computer-implemented method of claim 16, wherein the multiple segments are configured such that a set of pathways through the multiple segments is equivalent to a set of pathways through the program code as a whole to enable static analysis of program code using the individual segments to occur faster relative to analysis of the program code as a whole.

18. The computer-implemented method of claim 16, wherein the multiple segments are configured to enable static analysis of individual segments to occur with a higher success rate than analysis of the program code as a whole.

19. The computer-implemented method of claim 16, wherein the multiple segments are configured to enable static analysis of individual segments to generate fewer non-useful results relative to analysis of the program code as a whole.

20. The computer-implemented method of claim 16, further comprising combining results of static analysis performed individually upon the multiple segments to obtain results for the program code as a whole for output via an output device.
